(19) United States
(12) Patent Application Publication
(10) Pub. No.: US 2024/0385593 A1
(43) Pub. Date: Nov. 21, 2024

(54) A process system comprising a mechanical vapor compression (MVC/MVR) subsystem and a method for operating a process system

(71) Applicant: Aquafair AB, Sigtuna (SE)

(72) Inventors: Bert-Olof ÅHRSTRÖM, Örnsköldsvilk (SE); Fredrik CARLMAN, Sigtuna (SE)

(73) Assignee: Aquafair AB, Sigtuna (SE)

(21) Appl. No.: 18/696,587

(22) PCT Filed: Sep. 8, 2022
(86) PCT No.: PCT/EP2022/074979

§ 371 Date: Mar. 28, 2024

(30) Foreign Application Priority Data
Sep. 28, 2021 (EP) 21199491.8

(51) Int. Cl. G05B 19/4155

(52) U.S. Cl. CPC G05B 19/4155; G05B 2219/35111

(57) ABSTRACT

A process system comprising a mechanical vapor compression (MVC/MVR) subsystem arranged to receive a liquid and arranged to produce compressed vapor from the liquid and to heat the liquid being received is disclosed. The MVR-subsystem is arranged as a closed loop vapor MVR-subsystem arranged to reuse the produced vapor. The process system comprises a process subsystem connected to the MVC/MVR-subsystem and arranged to receive a branched portion of the compressed vapor, wherein the process subsystem is arranged to use the branched portion of the compressed vapor during operation of the process subsystem. A method for operating a process system is also disclosed.

### CROSS-REFERENCE TO RELATED APPLICATIONS

The instant application is a U.S. National Stage application of and claims priority to PCT/EP2022/074979, filed on Sep. 8, 2022, which is a PCT application of and claims priority to EP application Ser. No. 21/199,491.8, filed on Sep. 28, 2021, the subject matter of both aforementioned applications is hereby incorporated by reference in their entireties.

### TECHNICAL FIELD

The present disclosure relates to a process system comprising a mechanical vapor compression (MVC/MVR) subsystem, in particular it relates to a process system comprising MVC/MVR liquid purification subsystem. Further, the present disclosure relates to a method for operating a process system comprising a MVC/MVR-subsystem.

### BACKGROUND

Mechanical Vapor Compression (MVC) or also called Mechanical Vapor Recompression (MVR) is an evaporation method by which a blower, compressor or jet ejector is used to compress, and as a result of the compression, increase the pressure, density and temperature of the vapor produced.

As a result, the vapor can serve as the heating medium for its “mother” liquid or solution being concentrated. Without the compression, the vapor would be at the same temperature as its “mother” liquid/solution, and no heat transfer could take place.

Below some patent documents within the technical field will be briefly discussed.

In the U.S. Pat. No. 10,793,483 a system is described using a mechanical vapor recompression evaporator (MVR) to receive a liquid fraction from a centrifuge and evaporating the liquid fraction by mechanical vapor recompression to produce ammonia-laden water vapor and a concentrated nutrient slurry. The system comprises a dryer for drying the nutrient slurry to a selected moisture content to be available as an ingredient in compounded fertilizer; and an ammonia stripping tower assembly to receive ammonia-laden water vapor from the MVR and from it to precipitate ammonium sulphate salt and condense water as separate products.

In the EP2716341 a system and a method is described for liquid treatment by mechanical vapor recompression comprising a fixed fluid-tight evaporator housing. The housing comprises an inlet for feeding liquid to be evaporated into the housing and an outlet from the housing for liquid concentrated by evaporation and an outlet from the housing for discharging vapor boiled off from the liquid by evaporation. The housing comprises a plurality of heating elements within the housing mounted on a common horizontal axis, each of said heating elements having an outer surface for contact with said liquid to be evaporated within the housing and having an internal passage for heating medium and an element inlet and an element outlet for the heating medium.

Although the known systems work well, there is a need of improvements regarding utilization of energy from a MVR in an efficient manner.

Thus, the general object of the present disclosure is to achieve a process system comprising a mechanical vapor compression (MVC/MVR) subsystem, which process system has conditions for an improved utilization of energy produced by the MVR-subsystem. Further, an object of the present disclosure is to achieve an improved method for operating a process system comprising a MVC/MVR-subsystem, which process system can be operated in an efficient manner regarding the use of energy produced by the MVC/MVR-subsystem

### SUMMARY

The above-mentioned objects are achieved by the present disclosure according to the independent claims.

Preferred embodiments are set forth in the dependent claims.

According to one aspect, the present disclosure relates to a process system comprising a mechanical vapor compression (MVC/MVR) subsystem arranged to receive a liquid and arranged to produce compressed vapor from the liquid and to heat the liquid being received. The MVC/MVR-subsystem is a subsystem arranged to operate according to MVR-principle where compressed vapor is reused. The MVR-subsystem is arranged in a specific way characteristic for the MVR technology.

MVR-subsystem is arranged as a closed loop vapor MVR-subsystem arranged to reuse the produced vapor. Thus, vapor can be used in an efficient manner by being reused in the MVR-subsystem.

The MVC/MVR-subsystem is configured to receive a liquid to be used in the MVC/MVR-subsystem to produce compressed vapor. Thus, the MVC/MVR-subsystem is arranged to mainly operate with a liquid as an input to the MVC/MVR-subsystem.

The process system comprises a process subsystem connected to the MVC/MVR-subsystem and arranged to receive a branched portion of the compressed vapor, wherein the process subsystem is arranged to use the branched portion of the compressed vapor during operation of the process subsystem.

In the application, with the process subsystem is meant a subsystem arranged to use or to process the received the branched portion of compressed vapor in order to achieve that the process subsystem is constructed for, i.e. to achieve that what is the purpose of the process subsystem, which purpose may be different purposes.

Because the process system comprises the process subsystem connected to the MVC/MVR-subsystem, which process subsystem is arranged to receive a branched portion of the compressed vapor, the branched portion of the compressed vapor can be used in the process subsystem for the purpose of the process subsystem. Thus, depending on what is the aim/purpose of the process subsystem, the branched portion of the compressed vapor can be used to achieve the aim/purpose of the process subsystem.

As a result, a portion of energy produced by the MVC/MVR-subsystem can be used in the process subsystem by means of the branched portion of the compressed vapor provided to the process subsystem. Thus, an improved process system is achieved comparing to the known systems, which process system has conditions for an improved use of energy produced by the MVC/MVR-subsystem. This because the MVC/MVR-subsystem can operate according to the principle of closed loop operation and receiving a liquid and produce compressed vapor from the liquid and to heat the liquid and also to deliver the branched portion of the compressed vapor to the process subsystem for a use in the process subsystem. Therefore, the above-mentioned object is achieved.

Optionally, the process subsystem is a production subsystem configured to produce a product, wherein the branched portion of the compressed vapor can be used to product the product. Thus, the aim/purpose of the process system can be production of a product, such as manufacturing of a product where compressed vapor are needed during manufacturing of the product. The aim/purpose of the process system can also be preparation of a substance.

Optionally, the production subsystem is an industrial production subsystem and the product is an industrial product. Thus, the production subsystem can be, for example, a subsystem in a paper industry process, a food industry process or a steel industry process. In the case of preparation of a substance, the production subsystem can be, for example, a subsystem in a petroleum industry process.

Optionally, the process subsystem is a service subsystem configured to perform a service using the branched portion of the compressed vapor such as a cleaning procedure. Thus, the portion of the compressed vapor can be used, for example, to clean a façade of a building, for cleaning cloths or for sterilization purposes in hospitals or in laboratories.

Optionally, the process subsystem is a work generating subsystem. Thus, the portion of the compressed vapor can be used to generate work by the work generating subsystem. Consequently, the work generating subsystem can be a machine arranged to use compressed vapor to generate work.

Optionally, the work generating subsystem is a transport subsystem configured for freight- and/or public-transport. The transport subsystem can be a steam locomotive.

Optionally, the MVC/MVR-subsystem is a MVC/MVR liquid purification subsystem. Thus, an improved process system is provided having conditions for producing pure liquid by means of the MVC/MVR-subsystem and for using the portion of the compressed vapor during operation of the process subsystem.

Optionally, the MVC/MVR liquid purification subsystem is a MVC/MVR water desalination subsystem.

Optionally, the liquid is water. Thus, a yet improved process system is provided having conditions for producing pure fresh water by means of the MVC/MVR-subsystem and for using the portion of the compressed vapor during operation of the process subsystem.

According to a further aspect the present disclosure relates to a method for operating a process system comprising a mechanical vapor compression (MVC/MVR) subsystem arranged to receive a liquid and arranged to produce compressed vapor from the liquid and to heat the liquid being received, wherein the MVR-subsystem is arranged as a closed loop vapor MVR-subsystem arranged to reuse the produced vapor. The method comprises:
connecting a process subsystem to the MVC/MVR-subsystem and
providing a branched portion of the compressed vapor produced by the MVC/MVR-subsystem to the process subsystem, wherein the branched portion of the compressed vapor is to be used during operation of the process subsystem.

Because the process subsystem is connected to the MVC/MVR-subsystem, and because the method comprises the step of providing the branched portion of the compressed vapor to the process subsystem, the branched portion of the compressed vapor can be used in the process subsystem for the aim/purpose of process subsystem. Thus, depending on what is the aim/purpose of the process subsystem, the branched portion of the compressed vapor can be used to achieve the aim/purpose of the process subsystem.

Thus, the process subsystem can utilize a portion of energy produced by the MVC/MVR-subsystem by using the branched portion of the compressed vapor produced in the MVC/MVR-subsystem in the process subsystem.

Consequently, an improved method for operating a process system is provided and therefore, the above mentioned object is achieved.

Optionally, the process subsystem is a production subsystem configured to produce a product, wherein the method comprises to produce the product by the production subsystem. Thus, the aim/purpose of the process subsystem can be production of a product, such as manufacturing of a product where compressed vapor are needed during manufacturing of the product. The aim/purpose of the process subsystem can also be preparation of a substance.

Optionally, the process subsystem is a service subsystem configured to perform a service using the branched portion of the compressed vapor, wherein the method comprises to provide a service by the service subsystem, such as a cleaning procedure. Thus, the branched portion of the compressed vapor can be used, for example, to clean a façade of a building, for cleaning cloths or for sterilization purposes in hospitals or in laboratories.

Optionally, the process subsystem is a work generating subsystem, wherein the method comprises to provide work by the work generating subsystem, such as for freight- and/or public-transport. Thus, the branched portion of the compressed vapor can be used to generate work in the work generating subsystem. Consequently, the work generating subsystem can be a machine arranged to use compressed vapor to generate work.

### BRIEF DESCRIPTION OF THE DRAWINGS

FIG. 1 shows a schematic illustration of a process system according to an embodiment.

### DETAILED DESCRIPTION

A process system with a MVC/MVR-subsystem will now be described in details with references to the appended figures. Throughout the figures the same, or similar, items have the same reference signs. Moreover, the items and the figures are not necessarily to scale, emphasis instead being placed upon illustrating the principles of the invention.

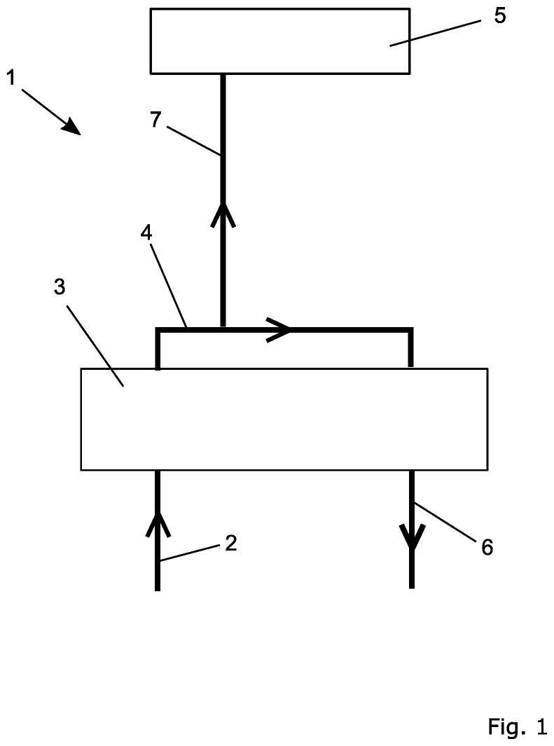

With reference to FIG. 1, a process system 1 comprising a mechanical vapor compression (MVC) or also called mechanical vapor recompression (MVR) subsystem 3 is illustrated according to some embodiments.

The MVR-subsystem 3 is arranged as a closed loop vapor MVR-subsystem arranged to reuse the produced vapor. The MVR-subsystem 3 is a subsystem arranged to operate according to MVR-principle known in the art where compressed vapor is reused. The MVR-subsystem 3 is arranged in a specific way characteristic for MVR technology. The MVC/MVR-subsystem 3 is a common knowledge in the art and is therefore not described herein in more details.

The process system 1 comprises a mechanical vapor compression (MVC/MVR) subsystem 3. arranged to receive a liquid and arranged to produce compressed vapor from the liquid and to heat the liquid being received. The liquid is supplied to the MVC/MVR-subsystem 3 through a liquid supply line 2. The compressed vapor are transported through a compressed vapor line 4. The heated liquid is transported through a heated liquid line 6.

The liquid may be water or the liquid may be any other liquid or mixture of liquids and/or other materials e.g. solids, polymers, fatty alcohols, oils, additives, soluble or insoluble particles and molecular systems including ionic fluids. The heated liquid may then be a heated cleaned water. Thus, the MVC/MVR-subsystem 3 may be a MVC/MVR liquid purification subsystem, particularly a MVC/MVR water desalination subsystem.

According to the embodiments illustrated in FIG. 1, the process system 1 comprises a process subsystem 5 connected to the MVC/MVR-subsystem 3 by means a compressed vapor portion line 7 illustrated with dashed line. Thus, the process subsystem 5 can utilize a portion of energy produced by the MVC/MVR-subsystem 3 by using directly a portion of the compressed vapor. Thus, the process subsystem 5 can be directly connected to the MVC/MVR-subsystem 3 by means of the compressed vapor portion line 7 supplying the portion of the compressed vapor to the process subsystem 5. The portion of the compressed vapor is branched from the compressed vapor line 4 to the compressed vapor portion line 7.

Consequently, a portion of energy produced by the MVC/MVR-subsystem 3 can be used by direct connection of the process subsystem 5 to the MVC/MVR-subsystem 3.

The process subsystem 5 may be a production subsystem configured to produce a product, wherein the portion of the compressed vapor can be used to product the product. Thus, the aim/purpose of the process subsystem 5 can be production of a product, such as manufacturing of a product where compressed vapor are needed during manufacturing of the product. The aim/purpose of the process subsystem 5 can also be preparation of a substance. Further, the product may be an industrial product. Thus, the production subsystem 5 can be, for example, a subsystem in a paper industry process, a food industry process or a steel industry process where compressed vapor is needed for the mentioned processes. In the case of preparation of a substance, the production subsystem can be, for example, a subsystem in a petroleum industry process where compressed vapor is needed during processing of oil.

According to some embodiments, the process subsystem 5 is a service subsystem configured to perform a service using the portion of the compressed vapor such as a cleaning procedure. Thus, the portion of the compressed vapor can be used, for example, to clean a façade of a building, for cleaning cloths or for sterilization purposes in hospitals or in laboratories. The compressed vapor can then be supplied through suitable conduits and nozzles of the process subsystem 5.

According to some further embodiments, the process subsystem 5 is a work generating subsystem. Thus, the portion of the compressed vapor can be used to generate work by the work generation subsystem. Consequently, the work generating subsystem can be a machine arranged to use compressed vapor to generate work. The work generating subsystem may be a transport subsystem configured for freight- and/or public-transport, such as a steam locomotive.

Through the application the arrows illustrate the flow direction in the respective line.

What is claimed is:

1-13. (canceled)

14. A process system comprising a mechanical vapor compression (MVC/MVR) subsystem arranged to receive a liquid and arranged to produce compressed vapor from said liquid and to heat the liquid being received, wherein the MVR-subsystem is arranged as a closed loop vapor MVR-subsystem arranged to reuse the produced vapor, wherein:
the process system comprises a process subsystem connected to said MVC/MVR-subsystem and arranged to receive a branched portion of said compressed vapor, wherein the process subsystem is arranged to use said branched portion of the compressed vapor during operation of the process subsystem.

15. The process system according to claim 14, wherein said process subsystem is a production subsystem configured to produce a product, wherein the branched portion of the compressed vapor is used to product the product.

16. The process system according to claim 15, wherein the production subsystem is an industrial production subsystem and the product is an industrial product.

17. The process system according to claim 14, wherein said process subsystem is a service subsystem configured to perform a service using said branched portion of the compressed vapor, such as a cleaning procedure.

18. The process system according to claim 14, wherein said process subsystem is a work generating subsystem.

19. The process system according to claim 18, wherein the work generating subsystem is a transport subsystem configured for freight- and/or public-transport.

20. The process system according to claim 14, wherein the MVC/MVR-subsystem is a MVC/MVR liquid purification subsystem.

21. The process system according to claim 20, wherein the MVC/MVR liquid purification subsystem is a MVC/MVR water desalination subsystem.

22. The process system according to claim 14, wherein the liquid is water.

23. A method for operating a process system comprising a mechanical vapor compression (MVC/MVR) subsystem arranged to receive a liquid and arranged to produce compressed vapor from said liquid and to heat the liquid being received, wherein the MVR-subsystem is arranged as a closed loop vapor MVR-subsystem arranged to reuse the produced vapor, wherein, the method comprises:
connecting a process subsystem to said MVC/MVR-subsystem and
providing a branched portion of said compressed vapor produced by the MVC/MVR-subsystem to said process subsystem, wherein said branched portion of the compressed vapor is to be used during operation of the process subsystem.

24. The method according to claim 23, wherein the process subsystem is a production subsystem configured to produce a product, wherein the method comprises to produce the product by the production subsystem.

25. The method according to claim 23, wherein the process subsystem is a service subsystem configured to perform a service using said branched portion of the compressed vapor, wherein the method comprises to provide a service by the service subsystem, such as a cleaning procedure.

26. The method according to claim 23, wherein the process subsystem is a work generating subsystem, wherein the method comprises to provide work by the work generating subsystem, such as for freight- and/or public-transport.
